(19) United States
(12) Patent Application Publication
(10) Pub. No.: US 2016/0154903 A1
(43) Pub. Date: Jun. 2, 2016

(54) INFORMATION PROCESSOR, INFORMATION PROCESSING METHOD AND COMPUTER-READABLE STORAGE MEDIUM

(71) Applicant: KABUSHIKI KAISHA TOSHIBA, Minato-ku (JP)

(72) Inventors: Gaku ISHII, Kawasaki (JP); Kohei MARUCHI, Minato-ku (JP); Mikito IWAMASA, Shinagawa (JP)

(73) Assignee: KABUSHIKI KAISHA TOSHIBA, Minato-ku (JP)

(21) Appl. No.: 15/010,711

(22) Filed: Jan. 29, 2016

Related U.S. Application Data
(63) Continuation of application No. PCT/JP2014/071131, filed on Aug. 4, 2014.

(30) Foreign Application Priority Data
Aug. 2, 2013 (JP) 2013-161453

(51) Int. Cl. G06F 17/50

(52) U.S. Cl. CPC G06F 17/5004

(57) ABSTRACT

According to this embodiment, an information processor comprises an electrical connection relation generating unit which generates an electrical connection relation of a plurality of components by adjusting the electrical connection relation of the components determined by the number of connections which each component can make with other components and a kind of the components of each hierarchy, based on the number of the components of a predetermined kind that can be arranged in a given space and an electrical permissible amount of the component in a top layer of the hierarchy. The information processor comprises a spatial arrangement determining unit which determines spatial arrangement of the components of the predetermined kind, based on the electrical connection relation generated by the electrical connection relation generating unit and rules of the spatial arrangement of the components.

### CROSS-REFERENCE TO RELATED APPLICATIONS

This application is a continuation of International application No. PCT/JP2014/071131, filed on Aug. 4, 2014, the entire contents of which is hereby incorporated by reference, the international application No. PCT/JP2014/071131 claiming the benefit of priority from Japanese Patent Application No. 2013-161453, filed Aug. 2, 2013.

### FIELD

Embodiments described herein relate generally to an information processor, an information processing method and a computer-readable storage medium.

### BACKGROUND

A system including apparatuses such as an electrical machinery system is designed through designing equipment data and an installation layout of the system and designing an electric system of collecting power or distributing power, that is, an electrical connection relation of equipment, on the basis of the data.

For instance, when designing a power generating system which collects power generated in a power generator of renewable energy such as a photovoltaic power generating system, a plurality of templates indicating a configuration and a structure of the power generating system are prepared, a template which is most approximate to characteristics of a design object is selected, and parameters related to power generation or the like are changed in the template.

Also, for a power generating system that is not pertinent to the template, all design is manually carried out, and the design is carried out using a design assisting device which verifies appropriateness of a system configuration specified by an operator (hereinafter called a user) and electric characteristics thereof and generates equipment data. Also, in equipment layout design of the power generating system, a plurality of typical layout patterns are prepared, and a pattern or a combination of the patterns which is most suitable for an installation space is selected.

### CITATION LIST

### Patent Literature

[Patent Literature 1] Japanese Patent Laid-Open No. 2012-083989
[Patent Literature 2] Japanese Patent Laid-Open No. 2004-110727

### BRIEF DESCRIPTION OF THE DRAWINGS

FIG. 1 is a plan schematic diagram of a power generator and a structure used in the photovoltaic power generating system in the present embodiment.

FIG. 2 is a diagram for describing a horizontal separation distance D between the arrays in the present embodiment.

FIG. 3 is an example of the electrical connection relation of the components of the photovoltaic power generating system in the present embodiment.

FIG. 4 is a schematic block diagram illustrating a configuration of the information processor 1 in the present embodiment.

FIG. 5 is a schematic block diagram illustrating a configuration of the processing unit 13 in the present embodiment.

FIG. 6 is a diagram illustrating one example of a data structure of the spatial relation data in the present embodiment.

FIG. 7 is a diagram illustrating one example of the data structure of the connection relation data in the present embodiment.

FIG. 8 is a diagram illustrating the relation between the connection relation data and the spatial relation data in the present embodiment.

FIG. 9 is a diagram for describing one example of first processing of allocating the string group object in the present embodiment.

FIG. 10 is a diagram for describing one example of second processing of allocating the string group object in the present embodiment.

FIG. 11 is a diagram for describing another example of the second processing of allocating the string group object in the present embodiment.

FIG. 12 is one example of the data structure of the object data in the present embodiment.

FIG. 13 is a flowchart illustrating one example of the flow of the processing of the information processor 1 in the present embodiment.

FIG. 14 is a flowchart illustrating one example of the flow of the processing of generating the connection relation in the present embodiment.

FIG. 15 is a flowchart illustrating one example of the flow of the processing of adjusting the connection relation in the present embodiment.

FIG. 16 is a flowchart illustrating one example of the flow of the processing of generating the inter-object relation data in the present embodiment.

FIG. 17 is a flowchart illustrating one example of the detailed flow of the processing in step S401 in FIG. 16.

### DETAILED DESCRIPTION

According to this embodiment, an information processor that designs an target system in which a plurality of components are spatially arranged, the components whose kinds are different for each layer are electrically connected hierarchically, and electrical output of each component is inputted to a component in a next higher layer from the component. The information processor comprises an electrical connection relation generating unit which generates an electrical connection relation of the plurality of components by adjusting the electrical connection relation of the components determined by the number of connections which each component can make with other components and a kind of the components of each hierarchy, based on the number of the components of a predetermined kind that can be arranged in a given space and an electrical permissible amount of the component in a top layer of the hierarchy. The information processor comprises a spatial arrangement determining unit which determines spatial arrangement of the components of the predetermined kind, based on the electrical connection relation generated by the electrical connection relation generating unit and rules of the spatial arrangement of the components.

Hereinafter, an embodiment of the present invention will be described in detail with reference to the drawings. An information processor in the present embodiment designs an target system in which a plurality of components are spatially arranged, the components whose kinds are different for each layer are electrically connected hierarchically, and electrical output of each component is inputted to a component in a next higher layer from the component. Specifically, for instance, the information processor determines an electrical connection relation of the plurality of components and spatial arrangement of the components of predetermined kinds. The target system is an electrical machinery system, for instance. The present embodiment will be described assuming that the target system is a photovoltaic power generating system which is one of the electrical machinery systems, as one example.

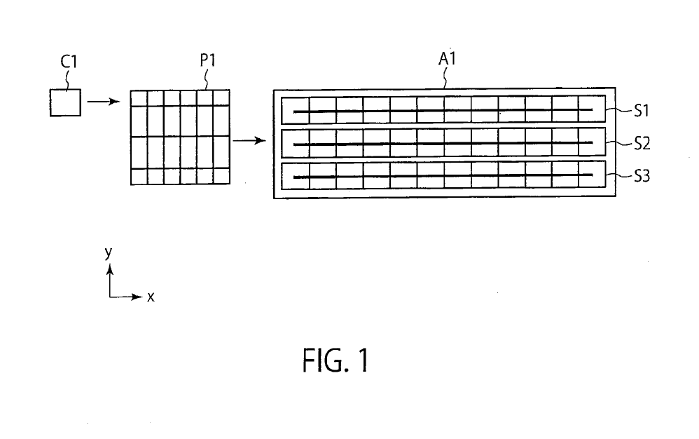

FIG. 1 is a plan schematic diagram of a power generator and a structure used in the photovoltaic power generating system in the present embodiment. In an xy space in the figure, a cell C1 which is a solar cell is illustrated. The cell C1 which is the solar cell converts incident light to a DC current. To a solar cell panel (hereinafter, also called as a panel), the solar cells are electrically connected. Also, in an example in FIG. 1, for a panel P1, as one example, 24 cells having the same characteristics as those of the cell C1 are electrically connected in series. Thus, a voltage from a cell at one end to a cell at the other end included in the panel P1 becomes 24 times greater than the voltage of the cell C1 alone.

A string is a power generating circuit in which the plurality of solar cell panels are electrically connected. In the example in FIG. 1, for strings S1, S2 and S3, 12 panels having the same characteristics as those of the panel P1 are connected in series in an x axis direction. Thus, a voltage from the panel at one end to the panel at the other end included in the strings S1, S2 and S3 becomes 12 times greater than the voltage of the panel P1 alone. The strings S1, S2 and S3 are electrically connected to each other in parallel. Thus, currents flowing through the strings S1, S2 and S3 can be combined. An array is the structure loaded with the solar cell panels. In the example in FIG. 1, an array A1 illustrates the structure loaded with the strings S1 to S3.

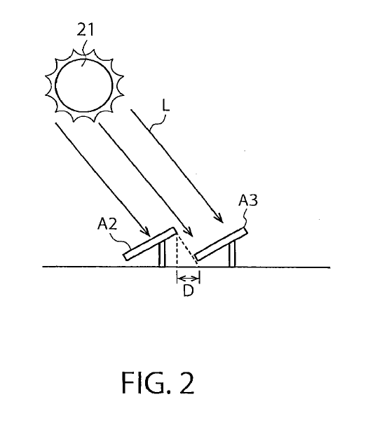

FIG. 2 is a diagram for describing a horizontal separation distance D between the arrays in the present embodiment. As illustrated in the figure, an array A2 and an array A3 are installed at a predetermined inclination angle to a ground surface. The horizontal separation distance D between the arrays is determined such that a shadow formed by irradiating the array A2 with light L from the sun 21 does not lie over the array A3. The horizontal separation distance D between the arrays is, for instance, such a distance that the shadow of the array A2 does not lie over the array A3 between 9:00 and 15:00 on the winter solstice.

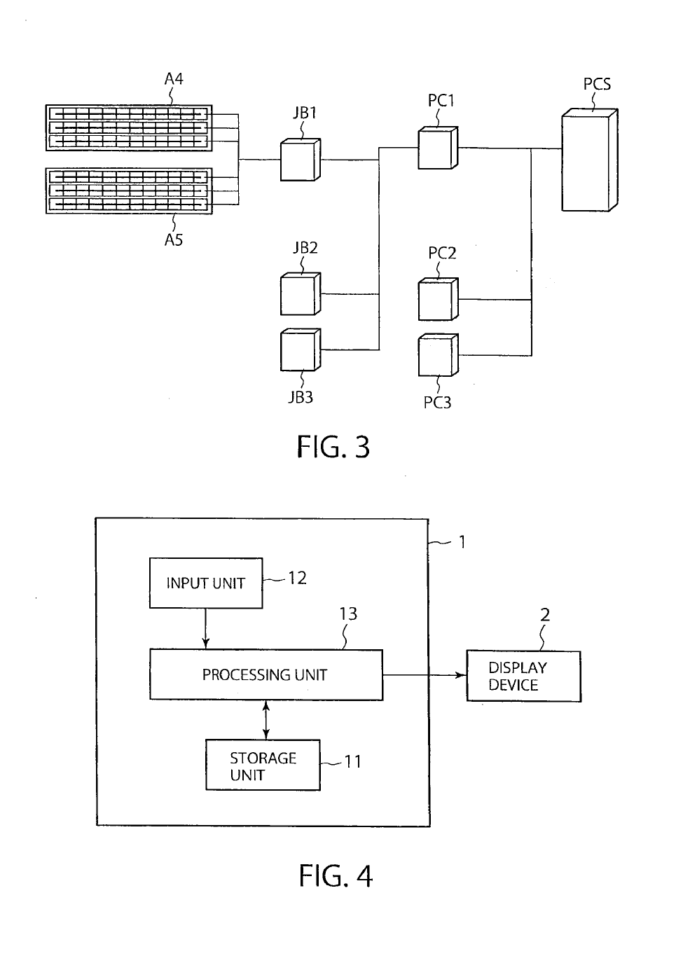

FIG. 3 is an example of the electrical connection relation of the components of the photovoltaic power generating system in the present embodiment. In the figure, three strings included in an array P4 and three strings included in an array A5 are electrically connected in parallel to a junction box JB1. Thus, the three strings included in the array A4 and the three strings included in the array A5 supply a DC current to the junction box JB1.

Also, the junction box JB1, a junction box JB2 and a junction box JB3 are electrically connected in parallel to a power collecting box PC1. Thus, the junction boxes JB1 to JB3 supply the DC current to the power collecting box PC1. The power collecting box PC1, a power collecting box PC2 and a power collecting box PC3 are electrically connected in parallel to a power conditioner (Power Conditioning System, hereinafter called a PCS). Thus, the power collecting boxes PC1 to PC3 supply the DC current to the PCS. The PCS converts a DC voltage supplied from the power collecting boxes PC1 to PC3 to an AC voltage and supplies the AC voltage to a power transmitting system, not shown in the figure, for instance. Here, the PCS is sometimes called a DC/AC converter.

In the present embodiment, as one example, the largest tree structure that is the electrical connection relation of the components, which can be taken from an electrical permissible amount of the PCS, is generated, and the number of the strings included in the generated tree structure is adjusted so that all the strings included in the tree structure can be arranged in a given lot. Thus, an information processor 1 in the present embodiment determines the arrangement of the arrays in the given lot, and determines the electrical connection relation of the individual strings included in the arrays.

FIG. 4 is a schematic block diagram illustrating a configuration of the information processor 1 in the present embodiment. As illustrated in the figure, the information processor 1 includes a storage unit 11, an input unit 12 and a processing unit 13.

In the storage unit 11, information needed for the processing unit 13 to carry out processing and a result of the processing are stored.

The input unit 12 is an interface for input, and is a keyboard or a touch panel, for instance. The input unit 12 receives input by a user. Specifically, for instance, the input unit 12 receives the input of a parameter by the user, and outputs input information related to the received input to the processing unit 13. Also, the input unit 12, for instance, receives a selection of the component to be a design object from the user and outputs selection information related to the received selection to the processing unit 13. Also, the input unit 12, for instance, receives a position correction instruction of the object by the user and outputs instruction information related to the received position correction instruction to the processing unit 13.

The processing unit 13 determines the spatial arrangement and the electrical connection relation of the plurality of components included in the target system, on the basis of the parameter inputted from the input unit 12. Here, in the target system, the plurality of components are spatially arranged, and each of the plurality of components is electrically connected with at least one different component. Then, the processing unit 13 stores a processing result obtained by the determination in the storage unit 11. Also, the processing unit 13 makes a display device 2 display the processing result.

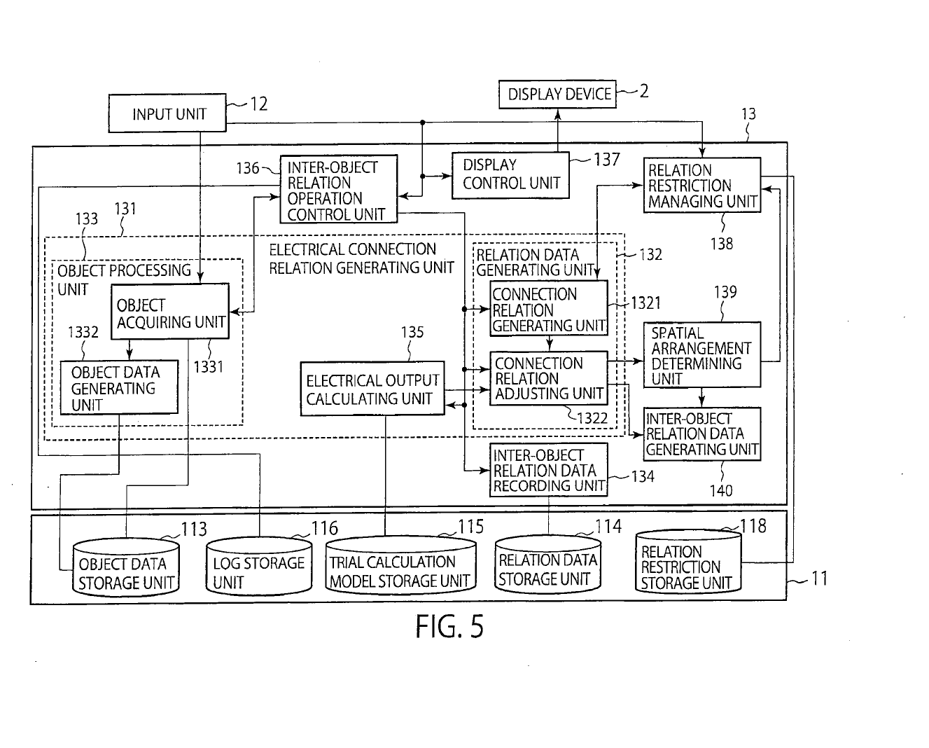

FIG. 5 is a schematic block diagram illustrating a configuration of the processing unit 13 in the present embodiment. The processing unit 13 includes an electrical connection relation generating unit 131, an inter-object relation data recording unit 134, an inter-object relation operation control unit 136, a display control unit 137, a relation restriction managing unit 138, a spatial arrangement determining unit 139, and an inter-object relation data generating unit 140. The electrical connection relation generating unit 131 includes a relation data generating unit 132, an object processing unit 133, and an electrical output calculating unit 135. Also, the storage unit 11 includes an object data storage unit 113, a relation data storage unit 114, a trial calculation model storage unit 115, a log storage unit 116, and a relation restriction storage unit 118.

In the trial calculation model storage unit 115, a trial calculation model is stored. Here, the trial calculation model is a model for calculating output power and output power energy to be outputted by all of the plurality of strings.

In the relation restriction storage unit 118, for instance, information related to a kind of the junction box (for instance, a model number of the junction box), and the number of terminals and allowable power of the junction box are stored in association. Here, the number of terminals of the junction box indicates the maximum number of the strings that can be connected.

In the relation restriction storage unit 118, for instance, information related to a kind of the power collecting box (for instance, a model number of the power collecting box), and the number of terminals and allowable power of the power collecting box are stored in association. Here, the number of terminals of the power collecting box indicates the maximum number of the junction boxes that can be connected. In the relation restriction storage unit 118, for instance, information related to a kind of the panel (for instance, a model number of the panel) and output power of the panel are stored in association.

The electrical connection relation generating unit 131 generates the electrical connection relation of the components by adjusting the electrical connection relation of the components determined by the number of connections which each component can make with other components and a kind of a component of each hierarchy, based on the number of the components of a predetermined kind that can be arranged in a given space and an electrical permissible amount of the component in the top layer of the hierarchy. In the present embodiment, the component in the top layer is, for instance, the power conditioner (PCS).

The relation restriction managing unit 138 updates a relation restriction of the target system. The relation restriction managing unit 138 determines the number of hierarchies of the electrical connection relation on the basis of the electrical permissible amount of a predetermined component. In more detail, the relation restriction managing unit 138, for instance, determines the number of the hierarchies of connection on the basis of a rated capacity of the PCS that is received by the input unit 12. When the rated capacity of the PCS is below a predetermined capacity (for instance, 250 kW), the relation restriction managing unit 138 determines the number of the hierarchies of the connection to be 3, for instance. When the rated capacity of the PCS is equal to or above the predetermined capacity (for instance, 250 kW), the relation restriction managing unit 138 determines the number of the hierarchies of the connection to be 4, for instance. The relation restriction managing unit 138 stores the updated relation restriction of the target system in the relation restriction storage unit 118.

The relation data generating unit 132 includes a connection relation generating unit 1321 and a connection relation adjusting unit 1322.

The connection relation generating unit 1321 generates the electrical connection relation of the components on a predetermined scale, on the basis of the number of connections which each component can make with other components and the kind of the component of each hierarchy. In the present embodiment, as one example, the predetermined scale is the maximum scale that can be taken in terms of electrical restrictions. Then, the connection relation generating unit 1321 outputs information indicating the generated electrical connection relation to the connection relation adjusting unit 1322.

Here, the number of connections which a component can make with other components is determined according to the kind of the component. The number of connections which a component can make with other components is, for instance, the maximum number of the strings connectable to the junction box which is determined according to the kind of the junction box, and the maximum number of the junction boxes connectable to the power collecting box which is determined according to the kind of the power collecting box.

Also, for instance, the kind of the component of each hierarchy is predetermined for each number of the hierarchies of the electrical connection relation. For instance, when the number of the hierarchies of the electrical connection relation is 4, as illustrated in FIG. 3, the string, the junction box, the power collecting box and the PCS are hierarchically connected in this order, for instance. When the number of the hierarchies of the electrical connection relation is 3, for instance, the string, the junction box and the PCS are hierarchically connected in this order. When the number of the hierarchies of the electrical connection relation is 3, the string, the power collecting box and the PCS may be hierarchically connected in this order without the layer of the junction box. Also, the string may be directly connected to the PCS.

In the present embodiment, in the relation restriction storage unit 118, for instance, the kind of the component of each hierarchy is stored for each number of the hierarchies of the electrical connection relation. Thus, by referring to the relation restriction storage unit 118, the relation restriction managing unit 138 acquires the kind of the component of each hierarchy corresponding to the determined number of the hierarchies of the electrical connection relation. Then, the connection relation generating unit 1321 acquires the kind of the component of each hierarchy from the relation restriction managing unit 138. Then, the connection relation generating unit 1321 generates the electrical connection relation of the components on the maximum scale which can be generated from the number of connections which each component can make with other components (hereinafter, also called the number of connection terminals) and the kind of the component of each hierarchy that is acquired by the relation restriction managing unit 138.

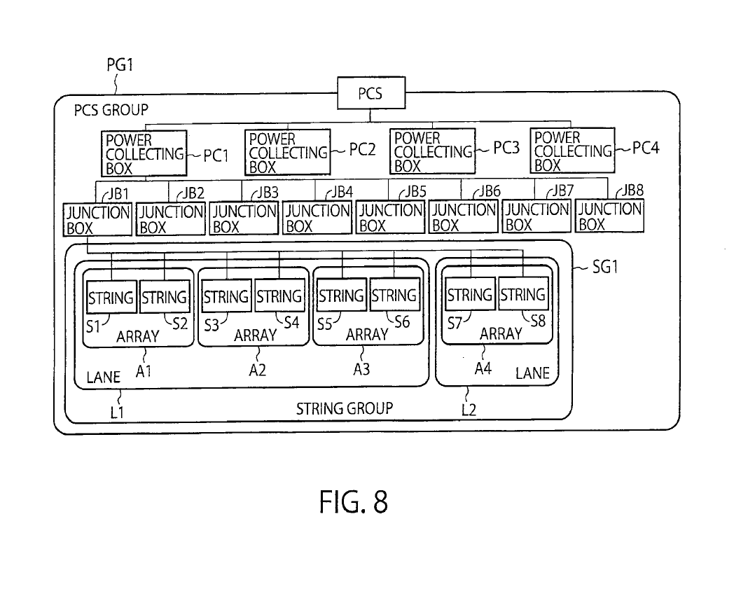

For instance, a case is assumed wherein the kind of the component of each hierarchy is the PCS, the power collecting box, the junction box and the string in this order form the highest layer, the number of the connection terminals of the PCS is 4, the number of the connection terminals of the power collecting box is 8, and the number of the connection terminals of the junction box is 8. In this case, the connection relation generating unit 1321 generates, for instance, a tree structure in which the PCS is electrically connected to four power collecting boxes, each power collecting box is electrically connected to eight junction boxes, and each junction box is electrically connected to eight strings, as the tree structure in FIG. 8.

The connection relation adjusting unit 1322 compares a sum of electrical output calculated by the electrical output calculating unit 135 and the electrical permissible amount of the component of the top layer of the hierarchy, and adjusts the number of the predetermined components in the electrical connection relation on the basis of the comparison result. Here, the component of the top layer is the PCS, for instance. Specifically, for instance, the connection relation adjusting unit 1322 compares the sum of the electrical output calculated by the electrical output calculating unit 135 and the electrical permissible amount of the PCS, and adjusts the number of the strings in the electrical connection relation on the basis of the comparison result. Then, the connection relation adjusting unit 1322 outputs information related to the electrical connection relation obtained by adjustment to the spatial arrangement determining unit 139 and the inter-object relation data generating unit 140.

The spatial arrangement determining unit 139 determines the spatial arrangement of the components of the predetermined kind on the basis of the electrical connection relation generated by the electrical connection relation generating unit 131 and rules of the spatial arrangement of the components. In more detail, the spatial arrangement determining unit 139 determines the spatial arrangement of the components of the predetermined kind on the basis of the electrical connection relation generated by the adjustment of the connection relation adjusting unit 1322 and rules of the spatial arrangement of the components. In the present embodiment, as one example, the electrical connection relation is a tree structure. The spatial arrangement determining unit 139 determines the spatial arrangement of the components of the predetermined kind so that the components of the predetermined kind within the same partial tree are spatially close to each other, for instance. In more detail, the spatial arrangement determining unit 139 determines the spatial arrangement of the strings so that the strings within the same partial tree are spatially close to each other, for instance. Then, the spatial arrangement determining unit 139 outputs information related to the determined spatial arrangement to the inter-object relation data generating unit 140.

Thus, by arranging the strings at spatially close positions, variation of distances from the individual strings to the junction boxes can be reduced. As a result, among the individual strings connected to the same junction box, variation of lengths of electric wiring from the strings to the junction box can be reduced. As described above, by reducing the variation of the lengths of the electric wiring, variation of power loss due to resistance is reduced, so that variation of power of individual terminals of the junction box to which the individual strings are connected is reduced. Therefore, the lowest power of the power of the individual terminals of the junction box to which the individual strings are connected is raised.

There is a characteristic that the power of the individual terminals of the junction box to which the individual strings are connected is drawn by the power of the terminal having the lowest power and drops to the power of the terminal having the lowest power. From that, by the rise of the lowest power of the power of the individual terminals of the junction box to which the individual strings are connected, even when the power of the individual terminals drops to the power of the terminal having the lowest power due to the characteristic, reduction of the power can be reduced. That is, the power loss can be reduced. Furthermore, by arranging the junction box at a position spatially close from the individual strings, the wiring can be shortened, and the power loss due to wiring resistance can be reduced.

The inter-object relation data generating unit 140 uses the information inputted from the spatial arrangement determining unit 139 to generate spatial relation data indicating a spatial position relation between the objects corresponding to the components. Here, the object is a set of information related to a shape, a position and a kind of the component. The information related to the shape of the component is positions of individual vertexes of the component, for instance.

The information related to the position of the component is coordinates (for instance, three-dimensional coordinates) of the individual vertexes of the component, for instance. The information related to the kind of the component is information indicating what the component is, for instance.

Also, the inter-object relation data generating unit 140 generates connection relation data indicating the electrical connection relation between the objects by associating the objects with the electrical connection relation using the information inputted from the connection relation adjusting unit 1322.

The object processing unit 133 includes an object acquiring unit 1331 and an object data generating unit (number-of-components acquiring unit) 1332.

The object acquiring unit 1331 acquires the object from the selection indicated by the selection information inputted from the input unit 12, from the plurality of objects generated by the object data generating unit 1332. The object acquiring unit 1331 outputs the input information inputted from the input unit 12 to the object data generating unit 1332, for instance. As described later, after the object data generating unit 1332 stores object data related to the object in the object data storage unit 113, the object acquiring unit 1331 acquires the object of a range of a lot received by the input unit 12 from the object data storage unit 113, for instance.

On the basis of information related to a range of a given space and information related to conditions of the arrangement of the component that are received by the input unit 12, the object data generating unit 1332 acquires the number of the components of the predetermined kind when the components of the predetermined kind are arranged at the maximum in the given space. Here, the component of the predetermined kind is the array, for instance. In the case of the example, the object data generating unit 1332 acquires the number of the arrays. The conditions of the arrangement of the component are, for instance, an installation angle of the array to a ground surface, a size of the array loaded with at least one string, and a horizontal separation distance between the plurality of arrays.

Then, the object data generating unit 1332 generates the objects (hereinafter called array objects) corresponding to the arrays for the acquired number of the arrays, for instance. Also, the object data generating unit 1332 generates the objects (hereinafter called string objects) corresponding to the strings included in the arrays for the acquired number of the arrays, for instance. Also, the object data generating unit 1332 generates the objects (hereinafter called panel objects) corresponding to the panels included in the arrays for the acquired number of the arrays, for instance. Here, the panel is a class for which the plurality of cells are gathered into one.

In such a manner, the object data generating unit 1332 generates the plurality of array objects corresponding to the maximum number of the arrays that can be installed in the given space. From that, the object data generating unit 1332 generates the plurality of objects corresponding to the respective components of the predetermined kind when the components of the predetermined kind are arranged at the maximum in the given space, on the basis of the information related to the range of the given space and the information related to the conditions of the arrangement of the component. The object data generating unit 1332 stores the object data related to the generated objects in the object data storage unit 113.

The inter-object relation data recording unit 134 stores inter-object relation data including the connection relation data and the spatial relation data generated by the inter-object relation data generating unit 140 in the relation data storage unit 114.

The electrical output calculating unit 135 calculates the sum of the electrical output, on the basis of the electrical output of each of the components (the panels, as one example) spatially included in the components (the arrays, as one example) the number of which is at least a part of the number among the number of the components (the arrays, as one example) of the predetermined kind acquired by the object data generating unit 1332. Then, the electrical output calculating unit 135 outputs information indicating the calculated sum of the electrical output to the connection relation adjusting unit 1322.

In the present embodiment, the electrical output calculating unit 135 calculates the sum of the electrical output on the basis of the electrical output of each of the components spatially included in the components corresponding to the plurality of objects acquired by the object acquiring unit 1331, for instance. In more detail, the electrical output calculating unit 135 calculates the sum of the output power and the sum of the output power energy of the individual panels spatially included in the arrays corresponding to the plurality of array objects acquired by the object acquiring unit 1331, for instance. At the time, the electrical output calculating unit 135 utilizes the trial calculation model stored in the trial calculation model storage unit 115, for instance, to calculate the sum of the output power and the sum of the output power energy.

One example of calculating processing of the sum of the output power will be described below. As a premise, in the storage unit 11, the model number of the panel and the output power of the panel are stored in association. Also, it is premised that the panels all having the same model number are to be used. On the premises, for instance, the input unit 12 receives the input of the model number of the panel by the user. The electrical output calculating unit 135 acquires the model number of the panel that is received through the input unit 12, for instance. Then, the electrical output calculating unit 135 acquires the output power of the panel corresponding to the acquired model number of the panel from the storage unit 11. Then, the electrical output calculating unit 135 calculates the sum of the output power of all the panels by multiplying the output power of the panel by the number of the panels.

The inter-object relation operation control unit 136 controls execution in the individual units. The inter-object relation operation control unit 136 stores logs related to the control in the log storage unit 116.

The display control unit 137 reads at least one of the connection relation data and the spatial relation data from the relation data storage unit 114. Then, the display control unit 137 makes the display device 2 display at least one of the connection relation data and the spatial relation data that is read.

Next, an example of a relation structure of the connection relation data and spatial relation and generation and management of the data will be described.

For instance, in the photovoltaic power generating system, the connection relation data expresses the connection relation of electrical apparatus objects corresponding to electrical apparatuses. Here, the electrical apparatuses are the apparatuses that exist in a system to the PCS from collecting electricity (DC) generated in the solar cell panel through serial and parallel circuits to converting it from the DC to an AC. The connection relation data indicates a logical relation of electrical connection by the expression of the hierarchies of the tree structure whose terminal node is the string for which the solar cell panels are connected in series. When expressing a DC system, it is expressed by the hierarchies of the tree structure in which the PCS is a root.

The process of generating the connection relation data by the connection relation generating unit 1321 is a state in which there is an electrical apparatus object which is not yet generated and does not exist, and in that case, the connection relation generating unit 1321 associates the electrical apparatus objects in immediate upper and lower orders in the electrical connection relation and configures the tree structure of the connection relation.

In the connection relation data, in addition to various kinds of electrical apparatus objects configuring the system, the following objects exist. They are group objects as entities of object set concepts (groups) that bind partial trees at or below a certain hierarchy in the tree structure indicating the logical relation of the electrical connection. For instance, there exists a string group object (STG-G) that binds the string objects in units of the number of the terminals or in units fewer than the number of the terminals of the junction box in the upper order of the string on the basis of a string node layer of the lowest order, and attains a set of the objects including the junction box.

The string group object expands the partial tree whose root is the junction box, and positions it in the higher order of the junction box. Also, for instance, there exists a PCS group object (PCS-G) that binds all the electrical apparatus objects and the group objects existing in the lower orders on the basis of a PCS node layer, and attains a set of the objects including the PCS. The PCS group object expands the partial tree whose root is the PCS and positions it in the higher order of the PCS.

In the completed connection relation data, the group object is, to be accurate, not in the hierarchy of the tree structure illustrating the logical relation of the electrical connection from the string to the PCS in the DC system, for instance, but is positioned as a node of one-higher-order hierarchy of the electrical apparatus object to be the root of the partial tree which is a group range. It is equivalent to expansion of the partial tree.

However, in the process of generating the connection relation data by the connection relation generating unit 1321, there is also the state that the electrical apparatus object to be the root does not exist yet. Therefore, in that case, as an object substituting it, that is, as an intermediate node where the electrical apparatus object is positioned in the tree structure illustrating the logical relation of the electrical connection, the connection relation generating unit 1321 intermediates the connection relation from the string to the PCS. Then, when the electrical apparatus object to be the root node is generated, the connection relation generating unit 1321 changes the connection relation in a form of expanding the partial tree.

Also, in the photovoltaic power generating system, the set of the electrical apparatus objects grouped by the group objects and the group objects satisfies spatial proximity restrictions as well. From that, it is the object in an inclusion relation to be described next, specifically, an entity of a partial spatial concept (division concept). For instance, the string group object means a junction box division object indicating a division of the entire strings connected to the same junction box in the spatial inclusion relation (see FIG. 8). The PCS group object means a PCS division object indicating a division of the entire power collecting boxes, junction boxes and strings connected under the PCS (see FIG. 8).

The spatial relation data indicates the spatial inclusion relation composed of divisions on the space to arrange the solar cell panels therein, and structures (arrays) for installing the solar cell panels to be arranged within the divisions. The arrays can also be expressed as divisions on the space to arrange the solar cell panels when the inside thereof is developed to the spatial inclusion relation. Thus, a nested structure of the divisions exists from the area of the highest order to the solar cell panels. The spatial arrangement determining unit 139 expresses the structure by the hierarchies of the tree structure whose root is an area specified by the user, for instance.

Also, the process of determining the spatial arrangement by the spatial arrangement determining unit 139 is a state wherein there is a division object which is not yet generated and does not exist, and in that case, the division objects in the immediate upper and lower orders in the spatial inclusion relation are associated with each another to configure the tree structure of the spatial relation.

Furthermore, in addition to the connection relation and the spatial relation, position relation data which specifies the position of the object may exist. The position relation data is related to lanes that divide the space under a certain rule, and indicates a lane object where the object is positioned. The spatial arrangement determining unit 139 allocates a uniquely identifiable management ID (index) to the lane object, for instance. Then, the spatial arrangement determining unit 139 holds the index of the lane object where the object is positioned as an address on the arrangement, for instance.

Also, the spatial arrangement determining unit 139 holds data that associates the division object divided by the lane and the lane object, for instance. The data can be expressed by the tree structure whose root is the divided division object similarly to the connection relation and the spatial relation. The lane object is also the entity of the partial spatial concept (division concept) and is also the division of the space according to certain spatial restrictions.

The object data generating unit 1332 may use the lane object when determining the position of the object which satisfies the spatial restrictions in automatic arrangement and position correction of the object. Also, the spatial arrangement determining unit 139 may use the lane object when determining a proximity relation when grouping the objects of the electrical apparatuses and structures.

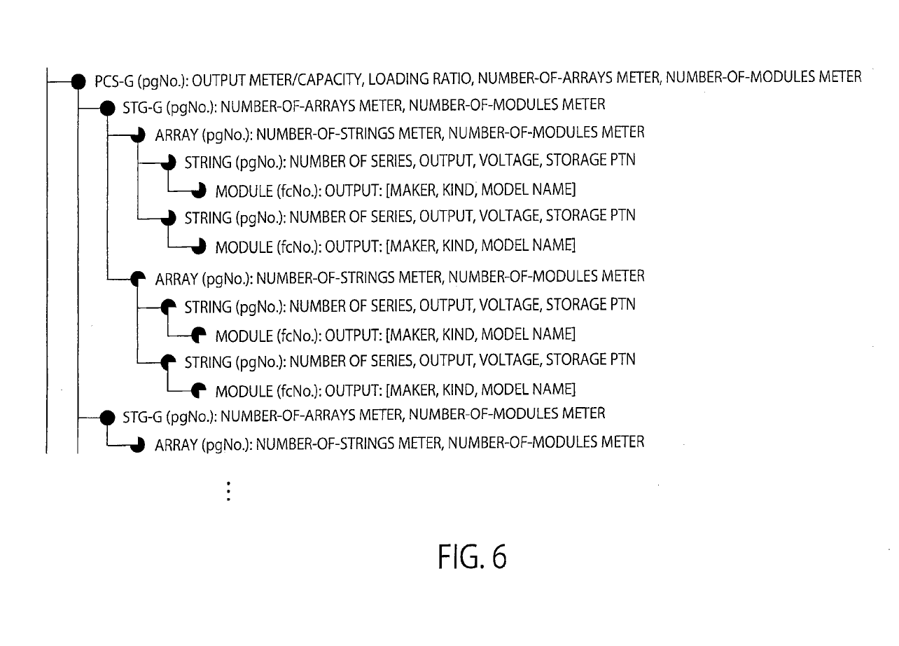

FIG. 6 is a diagram illustrating one example of a data structure of the spatial relation data in the present embodiment. As illustrated in the figure, the data structure of the spatial relation data takes the tree structure. The tree structure in the figure indicates the spatial inclusion relation, and is in such a relation that a parent node includes a child node right below it. As illustrated in the figure, the plurality of string group objects (STG-G) are included in the PCS group object (PCS-G). The PCS-G is a spatial area spatially including the STG-G. In an example in FIG. 6, each STG-G includes two arrays. The STG-G is a spatial area spatially including the two arrays. In the example in FIG. 6, each array includes two strings. In the example in the figure, the array is the division loaded with the two strings. Furthermore, as one example, each string includes a module that is a class for which the plurality of panels are gathered into one.

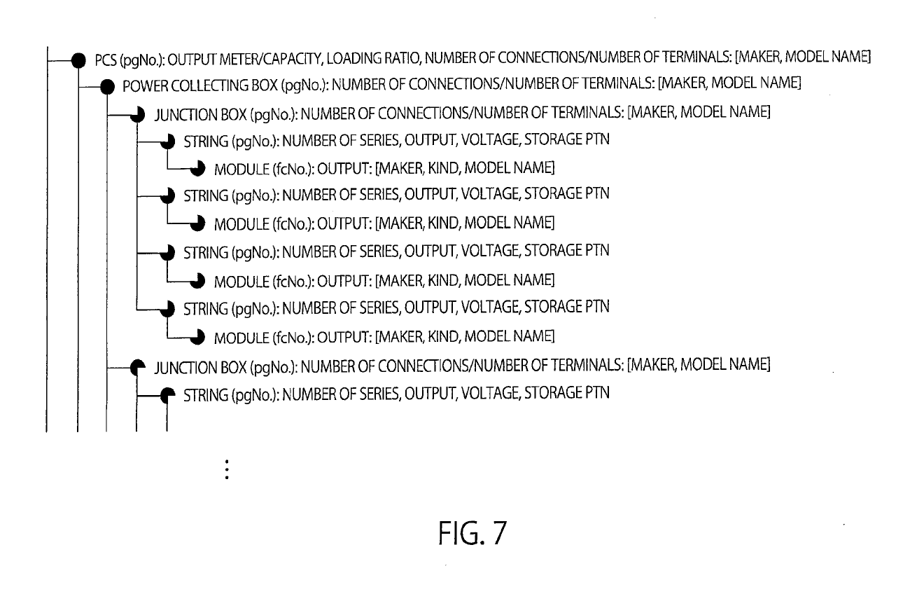

FIG. 7 is a diagram illustrating one example of the data structure of the connection relation data in the present embodiment. As illustrated in the figure, the data structure of the connection relation data takes the tree structure. The tree structure in the figure indicates the electrical connection relation, and the parent node is electrically connected to the child node right below it. The plurality of power collecting boxes are connected to the PCS. Furthermore, as one example, the plurality of junction boxes are connected to each power collecting box. Furthermore, as one example, four strings are connected to each junction box. Furthermore, as one example, one module is connected to each string.

FIG. 8 is a diagram illustrating the relation between the connection relation data and the spatial relation data in the present embodiment. First, the spatial relation illustrated in the figure will be described. A PCS group PG1 spatially includes a string group SG1. The string group SG1 is positioned over two of a lane L1 and a lane L2, thereby existing spatially over the two lanes. In an example in the figure, arrays A1 to A3 are arranged in the lane L1, and an array A4 is arranged in the lane L2.

Also, strings S1 and S2 are arranged in the array A1. Strings S3 and S4 are arranged in the array A2. Strings S5 and S6 are arranged in the array A3. Strings S7 and S8 are arranged in the array A4.

Next, the electrical connection relation illustrated in the figure will be described. Power collecting boxes PC1 to PC4 are connected to the PCS. Also, to the power collecting box PC1, junction boxes JB1 to JB8 are connected. The junction boxes connected to the other power collecting boxes PC2 to PC4 are omitted.

To the junction box JB1, the strings S1 to S8 are connected. Also, the strings connected to the other junction boxes JB1 to JB8 are omitted. In such a manner, the strings are common to both of the connection relation data and the spatial relation data.

<Detail of Processing of Associating Design Target Object with Connection Relation Satisfying Restriction of Spatial Relation>

One example of processing of associating a design target object with a connection relation satisfying the restriction of the spatial relation will be described. The restriction on the spatial relation indicates that an arbitrary object is in the proximity relation under a certain condition, for instance, and in this case, the number of terminal nodes belonging to a certain partial tree in the connection relation defines an arbitrary number.

For instance, when the number of the terminal nodes belonging to a partial tree A is “n”, the spatial arrangement determining unit 139 defines the number of the objects considered to be in the proximity relation as “n”, searches “n” objects that can be considered to be in the proximity relation under the certain condition, and associates the pertinent “n” objects with the individual terminal nodes of the partial tree A. That is, the spatial arrangement determining unit 139 carries out grouping by a defined number “n” based on the restriction on the proximity relation.

Next, the restriction on the proximity relation and one example of the processing will be described. The restriction on the proximity relation and the processing of grouping are not limited to the following example.

For instance, in the system like the photovoltaic power generating system with an installation environment under the same condition in order to make output of apparatuses that are operated in parallel uniform and the simplified arrangement in order to suppress a cost of installation construction, the arrangement is generally made systematic. The systematic arrangement indicates, for instance, the case where the front, back, left and right intervals between the objects are fixed, and the fact that the front, back, left and right intervals are fixed is the restriction on the spatial relation. Thus, the spatial arrangement determining unit 139 divides the space by the fixed interval applied to the arrangement.

For instance, in the case where the objects are aligned and the space is to be divided like car lanes (lanes) along lines, the spatial arrangement determining unit 139 preferentially groups the objects that are adjacent within the same lane. When carrying out grouping using the defined number “n”, the spatial arrangement determining unit 139 first groups the objects of the lane in which the defined number “n” or more of the objects exist, for instance. Then, the spatial arrangement determining unit 139 groups by the defined number “n” the objects that are not grouped, allowing them to be across the plurality of adjacent lanes.

At the time, for instance, the spatial arrangement determining unit 139 grasps a search space as a rectangle, and allocates one of the four corners as an origin when carrying out grouping. Here, the origin when carrying out grouping is an origin of scan when searching the lane in which the defined number “n” or more of the objects exist, and scan when searching the defined number “n” of the objects within the lane when carrying out grouping. For instance, in an object space having directions of north, south, east and west, when the lane is to be searched in a north-south direction and grouping in the lane is to be searched in an east-west direction, the spatial arrangement determining unit 139 allocates one of the four directions of northeast, northwest, southeast and southwest as the origin.

Also, when increasing priority of the restriction to be adjacent within the same lane, for instance, the spatial arrangement determining unit 139 relaxes the restriction on the defined number “n” (“n” is a positive integer) to be “n±m” (“m” is a positive integer smaller than “n”). Specifically, for instance, when the objects are across the plurality of adjacent lanes when the defined number is “n” but they all exist in the same lane when the defined number is “n−1”, that is, when only the object that is a grouping target last in the search scan exists in a different lane, the spatial arrangement determining unit 139 updates the defined number “n” to “n−1”, and carries out grouping. Next, when the spatial arrangement determining unit 139 allows the objects that are not grouped to be across the plurality of adjacent lanes and carries out grouping by the defined number “n”, for instance, the number of the lanes that the objects are to be thereover is different when the defined number is “n” and when it is “n−1”. At the time, when the number of the lanes is to increase when the object that is the grouping target last in the search scan is added, for instance, the spatial arrangement determining unit 139 updates the defined number “n” to “n−1” and carries out grouping.

When there are still the objects that are not the grouping target, for instance, when “k” objects (“k” is a positive integer) remain, the spatial arrangement determining unit 139 backtracks “k−1” generated groups, for instance, further reduces the defined number of grouping by 1, that is, turns it to “n−1−1” in this case, and carries out grouping. When there are still the objects that are not the grouping target, the spatial arrangement determining unit 139 may leave them as the objects that are not associated with the individual terminal nodes of the partial tree A without being able to satisfy the restriction on grouping, for instance.

Also, the range of a value that “m” can take is also restricted, and for instance, the restriction on the connection relation is applied. For instance, in the photovoltaic power generating system, in hierarchical parallel circuits from the string in which the solar cell panels are connected in series to the PCS, when the range of the variation of the number of parallel connections is to be within ±2 in consideration of the electrical restriction, the defined number for the time of grouping is to be “n±2”.

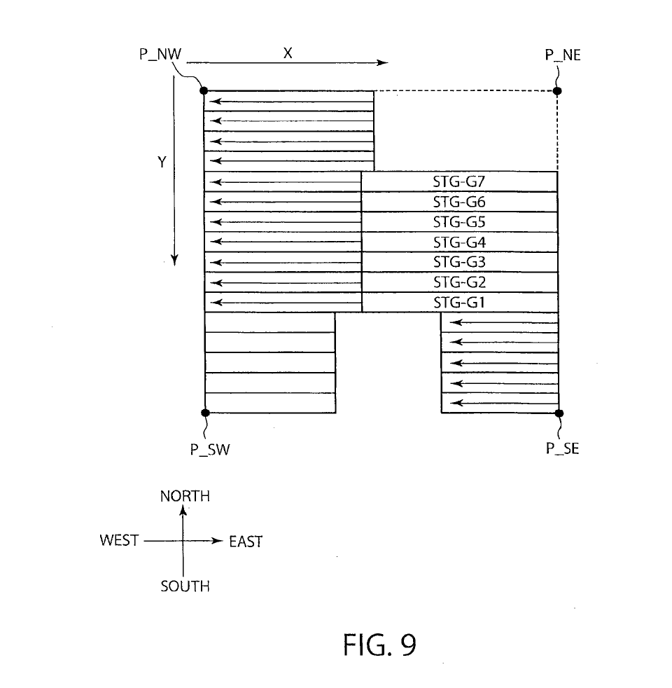

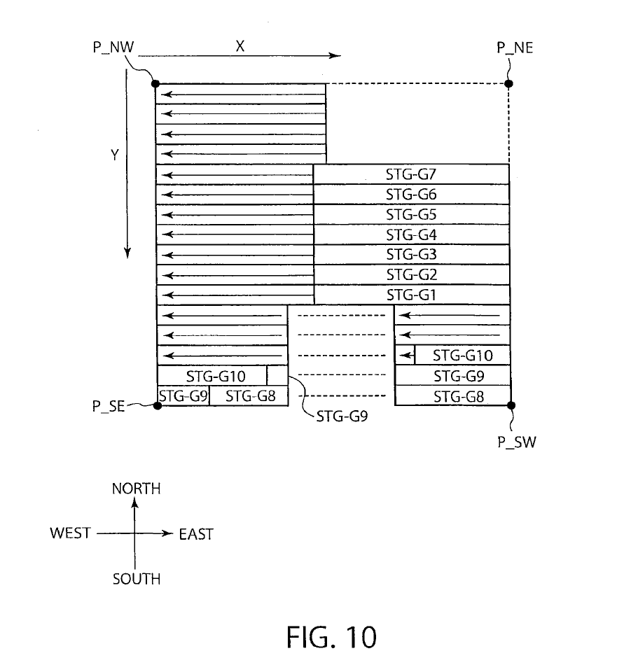

Using FIG. 9 and FIG. 10, one example of the processing of allocating the string group object to the lane allocated to the lot will be described. FIG. 9 is a diagram for describing one example of first processing of allocating the string group object in the present embodiment.

In FIG. 9 and FIG. 10, a description is given assuming that the string group object is composed of 8 strings. FIG. 9 is a schematic diagram in which the lanes are allocated to the lot. A northeast point P_NE, a southeast point P_SE, a northwest point P_NW, and a southwest point P_SW are indicated. In the figure, an arrow illustrates a direction of scanning whether or not the string group object is to be allocated.

First, the spatial arrangement determining unit 139 scans whether or not there is the space where 8 strings can be arranged continuously from an east end to a west end of the lane with the southeast point P_SE as the origin, for instance. When there is the space where 8 strings can be continuously arranged, the string group object is arranged. On the other hand, when there is no space where 8 strings can be continuously arranged, the string group object is not arranged. When the scan reaches the west end of the lane, the spatial arrangement determining unit 139 moves a scan target lane to the next lane to the north, and carries out the scan from the east end to the west end of the lane. The spatial arrangement determining unit 139 repeats the scan. In such a manner, the spatial arrangement determining unit 139 arranges the components within the partial tree (for instance, the strings connected to the same junction box or the strings connected to the same power collecting box) in the connection relation data in one line, for instance.

For instance, in the case of the lane including the southeast point P_SE, since there is no space where 8 strings can be continuously arranged, the spatial arrangement determining unit 139 does not arrange the string group object. On the other hand, since there is the space where 8 strings can be continuously arranged in the fifth lane to the north from the most southeast lane including the point P_SE, the spatial arrangement determining unit 139 arranges a string group object STG-G1 from the east of the lane as illustrated in FIG. 9. Furthermore, the spatial arrangement determining unit 139 determines whether or not there is the space where 8 strings can be arranged continuously from the west end of the arranged string group object STG-G1 in the lane, for instance.

Similarly, the spatial arrangement determining unit 139 determines whether or not there is the space where 8 strings can be continuously arranged every time of moving the scan target lane one up to the north. Then, when there is the space where 8 strings can be continuously arranged, the spatial arrangement determining unit 139 arranges the string group object, for instance. Thus, string group objects STG-G2 to STG-G7 are arranged. The spatial arrangement determining unit 139 determines whether or not there is the space where 8 strings can be continuously arranged also for the lanes in the north of the lane to which the string group object STG-G7 is allocated, for instance. In an example in FIG. 9, since there is no space where 8 strings can be continuously arranged in the lanes in the north of the lane to which the string group object STG-G7 is allocated, the spatial arrangement determining unit 139 does not arrange the string group object, for instance.

In such a manner, the spatial arrangement determining unit 139 determines the spatial arrangement of the components (for instance, the strings) of the predetermined kind so that the components (for instance, the strings) of the predetermined kind within the same partial tree are closely arranged in one line, as one example. The close arrangement in one line is the arrangement in order in one line at a predetermined distance interval. Here, the close arrangement includes not only the case where the components of the predetermined kind are in contact with each other but also the case where the components of the predetermined kind are installed away from each other by a predetermined distance.

The following processing will be described using FIG. 10. FIG. 10 is a diagram for describing one example of second processing of allocating the string group object in the present embodiment.

In one example of the second processing, the restriction on the arrangement is relaxed as follows. In the one example of the second processing, the spatial arrangement determining unit 139 is capable of, for instance, arranging the string group object over the plurality of lanes, and arranging the string group object over the two lanes that are spatially separated within the same line within the space. However, a scan direction is one direction that is the direction from east to west.

As illustrated in FIG. 10, the spatial arrangement determining unit 139 arranges a string group object STG-G8 over the two lanes that are spatially separated in the same line, for instance.

Also, as illustrated in FIG. 10, the spatial arrangement determining unit 139 arranges, for instance, a string group object STG-G9 over the two lanes, and also arranges the string group object STG-G9 over the two lanes that are spatially separated in the same line. Also, as illustrated in FIG. 10, the spatial arrangement determining unit 139 arranges a string group object STG-G10 over the two lanes, for instance. In such a manner, when all the string group object cannot be arranged in a certain line, for instance, the spatial arrangement determining unit 139 arranges the string group object over the next lane in the north from the lane. The spatial arrangement determining unit 139 repeats the processing. Thus, the spatial arrangement determining unit 139 can arrange the string group object in all the lanes.

In such a manner, for instance, in the tree structure indicating the electrical connection relation, the spatial arrangement determining unit 139 arranges the plurality of objects (for instance, the string objects) corresponding to the plurality of components within the same partial tree over the plurality of lanes. To be more abstract, when the components of the predetermined kind within the same partial tree cannot be closely arranged in one line, as one example, the spatial arrangement determining unit 139 determines the spatial arrangement of the components of the predetermined kind so that the components of the predetermined kind within the same partial tree are arranged in a partial space where the arrangement of the components of the predetermined kind is not determined yet in the given space, over the plurality of lines within the partial space.

Also, for instance, in the tree structure indicating the electrical connection relation, the spatial arrangement determining unit 139 arranges the plurality of objects (for instance, the string objects) corresponding to the plurality of components within the same partial tree over the plurality of areas that are spatially separated within the same line within the space. To be more abstract, when the components of the predetermined kind within the same partial tree cannot be closely arranged in one line, as one example, the spatial arrangement determining unit 139 determines the spatial arrangement of the components of the predetermined kind so that the components of the predetermined kind within the same partial tree are arranged in the partial space where the arrangement of the components of the predetermined kind is not determined yet in the given space, over the plurality of areas that are spatially separated within the same line within the partial space.

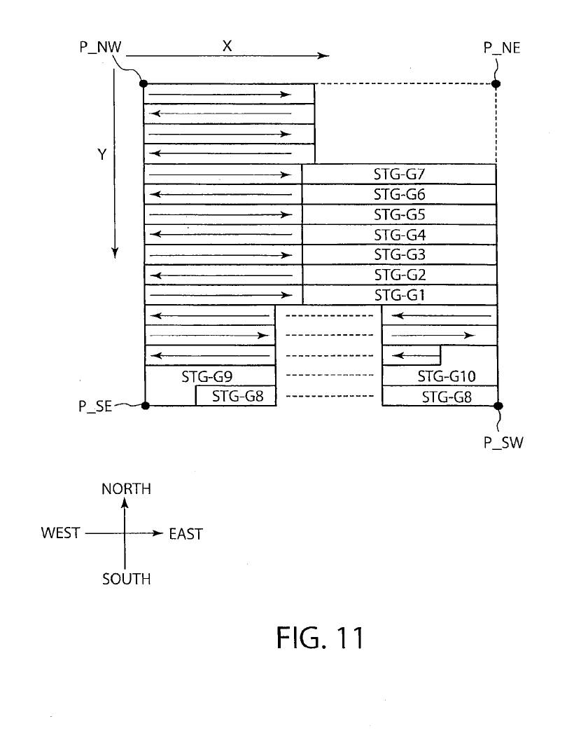

Also, the arrangement processing of the string group object in the second processing is not limited to the processing described using FIG. 10. FIG. 11 is a diagram for describing another example of the second processing of allocating the string group object in the present embodiment. In another example of the second processing, differently from the one example of the second processing illustrated in FIG. 10, the direction from east to west and the direction from west to east are alternately repeated for the scan direction.

As illustrated in FIG. 11, the spatial arrangement determining unit 139 arranges the string group object STG-G8 over the two lanes that are spatially separated in the same line, for instance.

Also, as illustrated in FIG. 11, the spatial arrangement determining unit 139 arranges the string group object STG-G9 so that the string objects are close over the two lanes, for instance. In such a manner, the spatial arrangement determining unit 139 arranges the plurality of objects corresponding to the plurality of components within the same partial tree so as to be close over the plurality of lanes in the tree structure indicating the electrical connection relation, for instance.

To be more abstract, when the components of the predetermined kind within the same partial tree cannot be closely arranged in one line, as one example, the spatial arrangement determining unit 139 determines the spatial arrangement of the components of the predetermined kind so that the components of the predetermined kind within the same partial tree are closely arranged in the partial space where the arrangement of the components of the predetermined kind is not determined yet in the given space, over the plurality of lines within the partial space.

By such arrangement, the spatial arrangement determining unit 139 can gather the strings included in the string group object STG-G9 in FIG. 11 in a closer range than the strings included in the string group object STG-G9 in FIG. 10. Therefore, the spatial arrangement determining unit 139 can make a distance between the string farthest from the junction box among the strings included in the string group object STG-G9 in FIG. 11 and the junction box shorter than a distance between the string farthest from the junction box among the strings included in the string group object STG-G9 in FIG. 10 and the junction box.

Therefore, since the spatial arrangement determining unit 139 can make the electric wiring between the string farthest from the junction box and the junction box shorter, a voltage drop due to resistance of the electric wiring can be reduced. Here, as described above, the voltages in the individual terminals of the junction box have the characteristic of becoming the lowest voltage among the voltages of the terminals that the junction box has. Considering the characteristic, the voltages in the individual terminals of the junction box to which the strings included in the string group object STG-G9 in FIG. 11 are connected can be made higher than the voltages in the individual terminals of the junction box to which the strings included in the string group object STG-G9 in FIG. 10. Therefore, in FIG. 11, the power loss can be made smaller compared to FIG. 10.

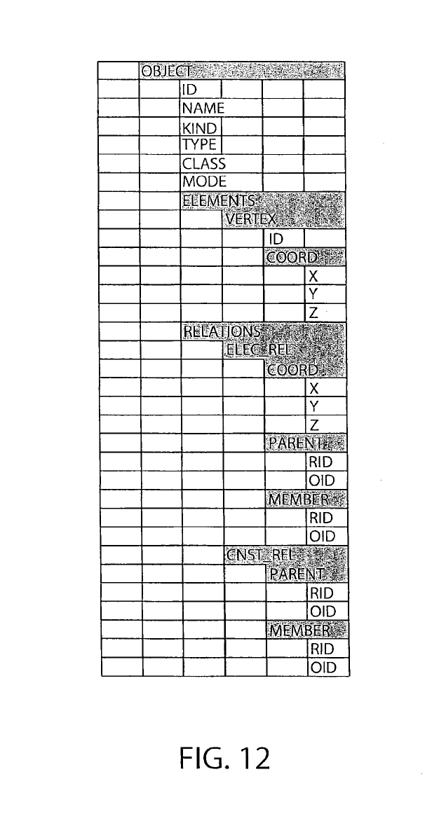

FIG. 12 is one example of the data structure of the object data in the present embodiment. In FIG. 12, the shape of the object corresponding to the component is a polygon as one example. For the object (OBJECT), an identifier ID, a name ID, a kind KIND, a type TYPE, an identifier CLASS of an applied equipment class, and a mode MODE are associated. Here, the equipment class includes the PCS, the power collecting box, the junction box and the panel. Also, elements ELEMENTS included in a polygonal object include the entire vertex elements VERTEX of the object. Individual vertex coordinates COORD are expressed by x coordinate, y coordinate and z coordinate.

Also, as inter-object relation definitions, there are an inter-object electrical relation ELEC_REL and an inter-object spatial relation CNST_REL. The inter-object electrical relation ELEC_REL includes the x coordinate, the y coordinate and the z coordinate as the coordinates COORD indicating the position of an electrical contact included in the object. Also, for a high-order (parent) object of the object, an identifier RID indicating the relation between the object and the high-order (parent) object and an identifier OID of the parent object are indicated. For a low-order (child) object of the object, the identifier RID indicating the relation between the object and the low-order (child) object and the identifier OID of the child object are indicated.

Also, as the inter-object spatial relation CNST_REL, for the high-order (parent) object of the object, the identifier RID indicating the relation between the object and the high-order (parent) object and the identifier OID of the parent object are indicated. For the low-order (child) object of the object, the identifier RID indicating the relation between the object and the low-order (child) object and the identifier OID of the child object are indicated.

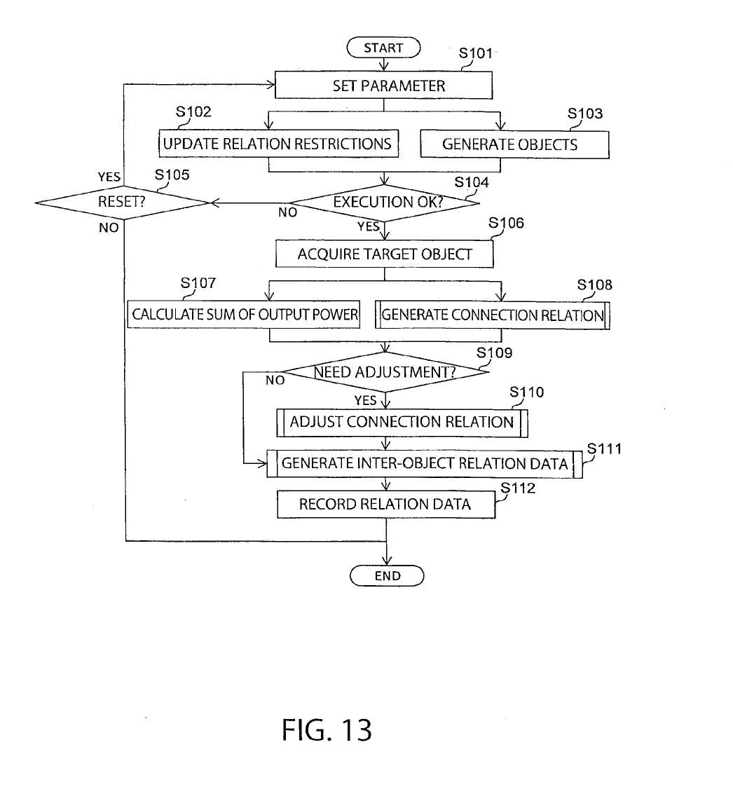

FIG. 13 is a flowchart illustrating one example of the flow of the processing of the information processor 1 in the present embodiment.

(Step S101) First, the input unit 12 receives the input of parameter setting by the user. The parameter setting is, for instance, the rated capacity of the PCS, the information related to the kind of the junction box (for instance, the model number of the junction box), the information related to the kind of the power collecting box (for instance, the model number of the power collecting box), positions of the individual vertexes of the lot to install the arrays, and information on which vertex each vertex is connected to, or the like.

The input unit 12 outputs, for instance, the rated capacity of the PCS, the information related to the kind of the junction box, and the information related to the kind of the power collecting box to the relation restriction managing unit 138. Also, the input unit 12 outputs, for instance, the positions of the individual vertexes of the lot to install the arrays, and the information on which vertex is connected to each vertex through the object acquiring unit 1331 to the object data generating unit 1332.

(Step S102) Next, the relation restriction managing unit 138 updates the restrictions of the electrical connection relation. For instance, the relation restriction managing unit 138 determines the number of the hierarchies of the electrical connection, on the basis of the rated capacity of the PCS that is inputted from the input unit 12. Specifically, for instance, when the rated capacity of the PCS that is inputted from the input unit 12 is smaller than the predetermined capacity, the relation restriction managing unit 138 determines 3 layers constituted of the respective layers of the PCS, the junction box and the string. On the other hand, for instance, when the rated capacity of the PCS that is inputted from the input unit 12 is equal to or greater than the predetermined capacity, the relation restriction managing unit 138 determines 4 layers constituted of the respective layers of the PCS, the power collecting box, the junction box, and the string. The relation restriction managing unit 138 stores the determined number of the hierarchies in the relation restriction storage unit 118.

(Step S103) In parallel to step S102, the object data generating unit 1332 acquires, for instance, information related to the range of the space and information related to condition of the arrangement of the components from the input unit 12. Here, the information related to the range of the space is, for instance, the positions of the individual vertexes of the lot to install the arrays and the information on which vertex is connected to each vertex. The information related to the condition of the arrangement of the components is, for instance, the information on lengths of the width and depth of the array, the inclination of the panel to the ground surface (that is, the inclination of the array to the ground surface), a separation distance between the arrays, and an azimuth angle of the panel (that is, an azimuth angle of the array) and an interval between the arrays, or the like.

The object data generating unit 1332 generates the plurality of array objects corresponding to the maximum number of the arrays that can be installed in the given space, on the basis of the information related to the range of the space and the information related to the condition of the arrangement of the components, for instance. Also, the object data generating unit 1332 generates the string objects corresponding to the strings spatially included in the maximum number of the arrays, for instance. Also, the object data generating unit 1332 generates the panel objects corresponding to the panels spatially included in the maximum number of the arrays, for instance. The object data generating unit 1332 stores the object data related to the generated array objects, string objects and panel objects in the object data storage unit 113, for instance.

(Step S104) Next, the input unit 12 receives, for instance, input of an execution permission (execution OK) or an execution non-permission (execution NG) by the user. The inter-object relation operation control unit 136 determines whether or not the input unit 12 receives the execution permission by the user. When the input unit 12 does not receive the input of the execution permission by the user, that is, when the input of the execution non-permission is received (NO), the inter-object relation operation control unit 136 advances to the processing in step S105. When the input unit 12 receives the input of the execution permission by the user (YES), the inter-object relation operation control unit 136 advances to the processing in step S106.

(Step S105) Then, the input unit 12 receives input on whether or not to perform resetting by the user, for instance. The inter-object relation operation control unit 136 determines whether or not the input unit 12 receives the input that the resetting by the user is to be performed. When the input unit 12 receives the input, that the resetting is to be performed, from the user (YES), the inter-object relation operation control unit 136 returns to the processing in step S101. On the other hand, when the input unit 12 does not receive the input, that the resetting is to be performed, from the user (NO), the inter-object relation operation control unit 136 ends the processing of the flowchart.

(Step S106) Then, the user inputs the range where it is desired to determine the arrangement of the arrays in the lot to install the arrays, for instance, to the input unit 12. In the present embodiment, as one example, a description is given assuming that the user inputs the range of the entire lot to install the arrays as the range where it is desired to determine the arrangement of the arrays to the input unit 12. The input unit 12 receives a user specified range inputted by the user, and outputs the received user specified range to the object acquiring unit 1331. Then, the object acquiring unit 1331 acquires the plurality of array objects corresponding to the plurality of arrays in the user specified range inputted from the input unit 12, from the object data stored in the object data storage unit 113.

Also, the object acquiring unit 1331 acquires the string objects corresponding to the plurality of strings loaded on the plurality of arrays, from the object data. Also, the object acquiring unit 1331 acquires the panel objects corresponding to the panels configuring the plurality of strings, from the object data. The object acquiring unit 1331 outputs the object data related to the acquired objects through the inter-object relation operation control unit 136 to the electrical output calculating unit 135. Also, the object acquiring unit 1331 outputs the acquired object data through the inter-object relation operation control unit 136 to the connection relation generating unit 1321.

In the present embodiment, the input unit 12 receives the input of the range where it is desired to determine the arrangement of the arrays, as one example, however, this is not something limited to it, and the input unit 12 may receive input specifying the individual arrays whose arrangement is desired to be determined, instead.

(Step S107) Next, the electrical output calculating unit 135 calculates the sum of the output power of all the panel objects included in the object data inputted from the object acquiring unit 1331. Specifically, for instance, the electrical output calculating unit 135 calculates the total sum of the output power of the individual panels included in the panels corresponding to all the panel objects included in the user specified range. Thus, the electrical output calculating unit 135 can calculate the sum of the output power of all the panels included in the user specified range.

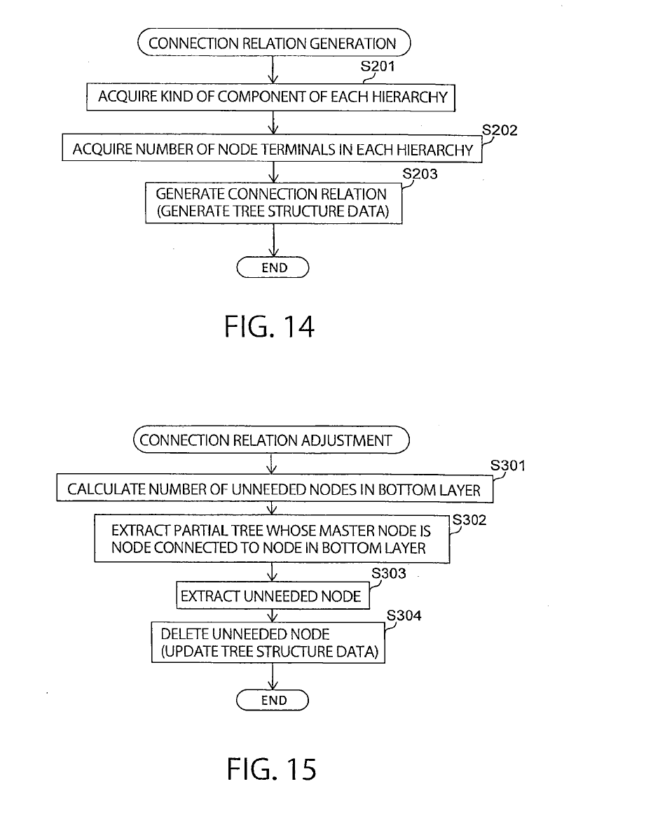

(Step S108) In parallel to step S107, the connection relation generating unit 1321 generates the electrical connection relation for the object data inputted from the object acquiring unit 1331. The detailed processing will be described later using FIG. 14.

(Step S109) The inter-object relation operation control unit 136 determines whether or not adjustment of the electrical connection relation is needed. Specifically, for instance, the inter-object relation operation control unit 136 determines whether or not the output power calculated by the electrical output calculating unit 135 and the rated capacity of the PCS received by the input unit 12 are different. When the output power calculated by the electrical output calculating unit 135 and the rated capacity of the PCS received by the input unit 12 are different (YES), advancement to the processing in step S110 is carried out. On the other hand, when the output power calculated by the electrical output calculating unit 135 and the rated capacity of the PCS received by the input unit 12 are equal (NO), advancement to the processing in step S111 is carried out.

(Step S110) Then, the connection relation adjusting unit 1322 adjusts the number of the objects in the electrical connection relation. The detailed processing will be described later using FIG. 15.

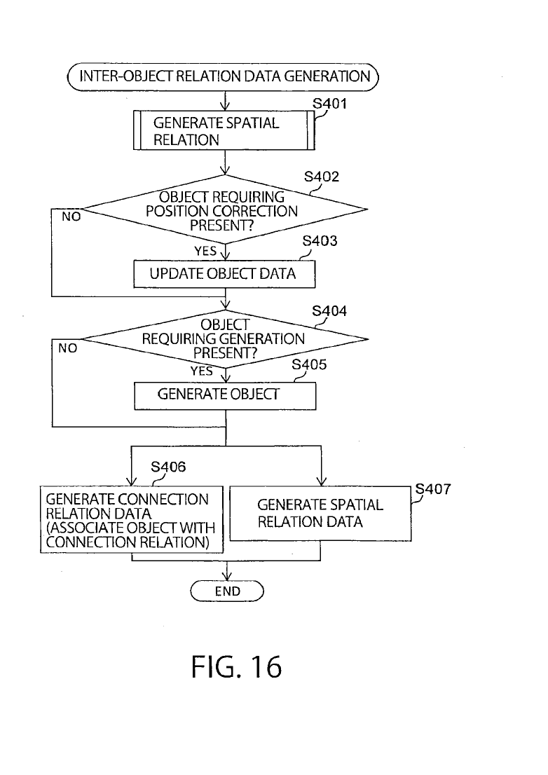

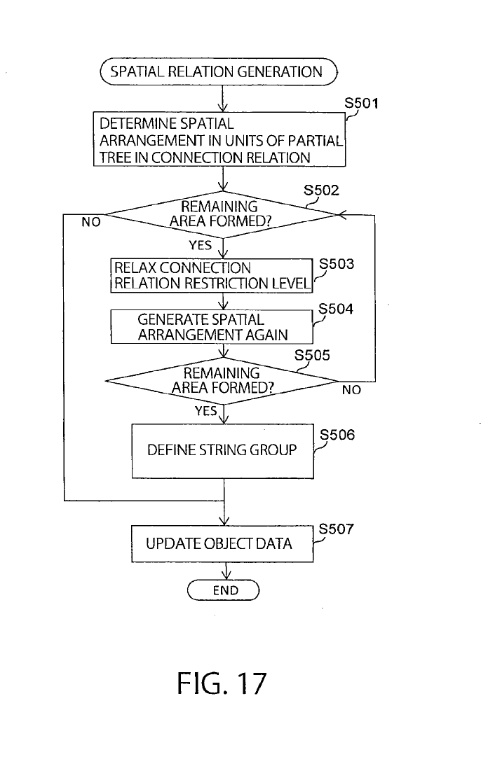

(Step S111) Next, the inter-object relation data generating unit 140 generates the inter-object relation data. Here, the inter-object relation data includes, as described above, the connection relation data indicating the electrical connection relation (see FIG. 6) and the spatial relation data indicating the spatial relation between the objects (see FIG. 7). The detailed processing will be described later using FIG. 16 and FIG. 17.

(Step S112) Next, the inter-object relation data recording unit 134 stores the inter-object relation data generated by the inter-object relation data generating unit 140 in the relation data storage unit 114. The processing of the flowchart is then ended.

In this way, the information processor 1 in the present embodiment can determine the spatial arrangement of the arrays and the electrical connection relation of the string, the junction box, the power collecting box, and the PCS for the range specified by the user. Thus, since the same spatial arrangement and electrical connection relation are obtained regardless of the user as long as the condition is the same, variation in design quality is not generated, and fixed design quality can be guaranteed at all times.

FIG. 14 is a flowchart illustrating one example of the flow of the processing of generating the connection relation in the present embodiment.

(Step S201) First, the relation restriction managing unit 138 acquires the number of the hierarchies of the system from the relation restriction storage unit 118. Then, the relation restriction managing unit 138 acquires the kinds of the components of the respective hierarchies corresponding to the acquired number of the hierarchies of the system from the relation restriction storage unit 118. Then, the relation restriction managing unit 138 outputs the acquired kinds of the components of the individual hierarchies to the connection relation generating unit 1321.

(Step S202) Then, the relation restriction managing unit 138 acquires the number of node terminals in the individual hierarchies of the system by the following processing, for instance. The relation restriction managing unit 138 reads the number of the terminals and the allowable power of the junction box corresponding to the information related to the kind of the junction box that is inputted from the input unit 12 from the relation restriction storage unit 118, for instance. Also, the relation restriction managing unit 138 reads the number of the terminals and the allowable power of the power collecting box corresponding to the information related to the kind of the power collecting box that is inputted from the input unit 12 from the relation restriction storage unit 118, for instance. Also, the relation restriction managing unit 138 reads the output power of the panel corresponding to the information related to the panel that is inputted from the input unit 12, for instance.

Then, the relation restriction managing unit 138 determines the maximum number of the strings that can be connected to the junction box in the range not exceeding the allowable power of the junction box, on the basis of the output power of the panel and the number of the terminals of the junction box, for instance. Also, the relation restriction managing unit 138 determines the maximum number of the junction boxes that can be connected to the power collecting box in the range not exceeding the allowable power of the power collecting box, on the basis of the allowable power of the junction box and the number of the terminals of the power collecting box, for instance. The relation restriction managing unit 138 outputs the acquired numbers of the node terminals in the individual hierarchies to the connection relation generating unit 1321.

(Step S203) Next, the connection relation generating unit 1321 generates the electrical connection relation of the components, on the basis of the numbers of the node terminals in the individual hierarchies and the kinds of the components of the individual hierarchies that are acquired from the relation restriction managing unit 138. Thus, as the electrical connection relation of the components, the data of the tree structure is generated. The processing of generating the connection relation is then ended.

FIG. 15 is a flowchart illustrating one example of the flow of the processing of adjusting the connection relation in the present embodiment.

(Step S301) First, the connection relation adjusting unit 1322 calculates the number of unneeded nodes in the bottom layer. At the time, for instance, the connection relation adjusting unit 1322 calculates unneeded power by subtracting the output power calculated by the electrical output calculating unit 135 from the rated capacity of the PCS. Then, the connection relation adjusting unit 1322 calculates the number of the strings equivalent to the unneeded power as the number of the unneeded nodes in the bottom layer. Specifically, for instance, when the user specifies the rated capacity of the PCS as 250 kW and the electrical output calculating unit 135 calculates 220 kW, there are the unneeded nodes for 30 (=250−220) kW. When it is assumed that output is 5 kW per string, the connection relation adjusting unit 1322 calculates 6 (=30/5) which is the number of the strings equivalent to 30 kW as the number of the unneeded nodes in the bottom layer, for instance.

(Step S302) Next, the connection relation adjusting unit 1322 extracts the partial tree whose parent node is the node to which the node of the bottom layer is connected, in the tree structure data generated by the connection relation generating unit 1321.

(Step S303) Then, the connection relation adjusting unit 1322 extracts the unneeded nodes from the partial tree extracted in step S302. The connection relation adjusting unit 1322 equally removes the nodes from the bottom layer nodes included in the extracted partial tree, by the number of the unneeded nodes in the bottom layer. For instance, when 8 partial trees are extracted and the number of the unneeded nodes in the bottom layer is 6, the connection relation adjusting unit 1322 extracts one node from the nodes in the bottom layer as the unneeded node, in 6 partial trees among the 8 partial trees.

(Step S304) Next, by deleting the unneeded nodes extracted in step S303, the connection relation adjusting unit 1322 updates the tree structure data.

FIG. 16 is a flowchart illustrating one example of the flow of the processing of generating the inter-object relation data in the present embodiment.

(Step S401) First, the spatial arrangement determining unit 139 determines the spatial arrangement of the objects, and updates the object data as illustrated in FIG. 12. The detailed processing will be described later using FIG. 17.

(Step S402) Next, the display control unit 137 makes the display device 2 display a question that whether there is the object requiring position correction. After the question is displayed, when the input unit 12 receives the input that there is the object requiring the position correction (YES), the inter-object relation operation control unit 136 advances to the processing in step S403. On the other hand, after the question is displayed, when the input unit 12 receives the input that there is no object requiring the position correction (NO), the inter-object relation operation control unit 136 advances to the processing in step S404.

(Step S403) Next, the inter-object relation data generating unit 140 updates the object data according to the position correction instruction of the object indicated by instruction information received by the input unit 12.

(Step S404) Then, the inter-object relation data generating unit 140 determines whether or not there is the object requiring generation. A concrete example of the processing will be described. Here, it is assumed that three strings are loaded on the array in the processing so far. Under such assumption, for instance, the inter-object relation data generating unit 140 determines whether or not there is a gap if a narrow (small-sized) array loaded with fewer strings than the already existing arrays, for instance, the array loaded with one string over three stages, can be put into, though not limited to this aspect, within the range specified by the user in step S106, and whether or not there is a margin in the number of the terminals in the junction box. When there is the gap that the array loaded with one string over three stages can be put into and there is the margin in the number of the terminals in the junction box (YES), advancement to the processing in step S405 is carried out. When there is no gap that the array loaded with one string over three stages can be put into or there is no margin in the number of the terminals in the junction box (NO), advancement to the processing in steps S406 and S407 is carried out.

(Step S405) Next, the inter-object relation data generating unit 140 generates the object to be installed in the gap, which is the object corresponding to the array loaded with one string over three stages, for instance.

(Step S406) Then, the inter-object relation data generating unit 140 generates the connection relation data indicating the electrical connection relation of the object by associating the object with the electrical connection relation of the component.

(Step S407) In parallel to step S406, the inter-object relation data generating unit 140 generates the spatial relation data indicating the inter-object spatial relation.

FIG. 17 is a flowchart illustrating one example of the detailed flow of the processing in step S401 in FIG. 16.

(Step S501) First, the spatial arrangement determining unit 139 determines the spatial arrangement of the objects in units of the partial tree included in the electrical connection relation. Specifically, the spatial arrangement determining unit 139 successively scans the lanes as illustrated in FIG. 9 and arranges the string group object in the same lane, for instance. Then, as illustrated in FIG. 10, for instance, the spatial arrangement determining unit 139 is capable of arranging the string group object over the plurality of lanes, and arranges the string group object over the two lanes that are spatially separated in the same line.

(Step S502) Next, the spatial arrangement determining unit 139 determines whether or not an area where the string group object is not arranged (hereinafter, called a remaining area) is formed within the range specified by the user. When the remaining area is formed (YES), advancement to the processing in step S503 is carried out. When the remaining area is not formed (NO), advancement to the processing in step S507 is carried out.

(Step S503) Then, the spatial arrangement determining unit 139 relaxes a connection relation restriction level. For instance, the spatial arrangement determining unit 139 relaxes the connection relation restriction level in array units. For instance, on the premise that the plurality of strings (“Sp” strings) are loaded on one array, when the number of the strings included in the string group object is N±M×S p (“N” is an integer equal to or larger than 0, and “M” is an integer equal to or larger than 0), the spatial arrangement determining unit 139 relaxes the connection relation restriction level by increasing or decreasing the value of “M” by 1. Specifically, for instance, when one array is loaded with three arrays, the spatial arrangement determining unit 139 configures the string group object not only by 6 strings but also by 9 strings when the number of the terminals of the junction box is 9 or larger.

Also, the spatial arrangement determining unit 139 may relax the connection relation restriction level not in the array units but in string units. For instance, on the premise that one string is loaded on one array, when the number of the strings included in the string group object is N±M (“N” is an integer equal to or larger than 0, and “M” is an integer equal to or larger than 0), the spatial arrangement determining unit 139 may relax the connection relation restriction level by increasing or decreasing the value of “M” by 1. Specifically, for instance, the spatial arrangement determining unit 139 may configure the string group object not only by 6 strings but also by 5 strings or by 9 strings.

(Step S504) Then, the spatial arrangement determining unit 139 determines the spatial arrangement of the objects again.

(Step S505) Next, the spatial arrangement determining unit 139 determines whether or not the remaining area is formed when the spatial arrangement is carried out again in step S504. When the remaining area is not formed (YES), advancement to the processing in step S506 is carried out. When the remaining area is formed (NO), return to the processing in step S503 is carried out.

(Step S506) Then, the spatial arrangement determining unit 139 defines the string group object grouped until the step of the previous stage as a formal string group object.

(Step S507) Then, the spatial arrangement determining unit 139 refers to the string group object defined in step S506, and updates the object data as illustrated in FIG. 12. At the time, the spatial arrangement determining unit 139 generates the object corresponding to the junction box and the object corresponding to the power collecting box, for instance.

In the information processor 1 in the present embodiment, the electrical connection relation generating unit 131 generates the electrical connection relation of the plurality of components by adjusting the electrical connection relation of the components determined by the number of connections which each component can make with other components and the kind of the components of each hierarchy, based on the number of the components of the predetermined kind that can be arranged in the given space and the electrical permissible amount of the component in the top layer of the hierarchy. Then, the spatial arrangement determining unit 139 determines the spatial arrangement of the plurality of components on the basis of the electrical connection relation generated by the electrical connection relation generating unit 131 and the rules of the spatial arrangement of the components.

Thus, since the same spatial arrangement and electrical connection relation are obtained regardless of the user as long as the condition is the same, the variation in the design quality is not generated, and the fixed design quality can be guaranteed at all times.

Furthermore, the information processor 1 can design an arbitrary system in which the objects corresponding to the components having spatial position information have the relation of being connected in a hierarchical form, like a system indicated by a hierarchical structure, the electrical machinery system, for instance. Thus, the information processor 1 can cover the design of the system of a small scale to the system of a large scale. Therefore, the information processor 1 can simultaneously achieve both of the equipment layout design and electric wiring design of a system of an arbitrary scale, for the electrical machinery system indicated by the hierarchical structure, the power generating system, for instance.

Also, in the information processor 1 in the present embodiment, the inter-object relation data generating unit 1323 generates the inter-object relation data including two relations of the spatial arrangement and electrical connection relations. Thus, the information processor 1 can seamlessly link the equipment layout design and the electric wiring design, generate equipment data which satisfies restrictions without tracing back of the data, accurately execute equipment data generation, and make the execution efficient.

The object acquiring unit 1331 compares a specification restriction of an target system with a system specification obtained from the set of the objects to be the design object, and when the system specification exceeds the specification restriction, may acquire the set of the objects having a specification that is most approximate to and smaller than the specification restriction of the target system, so as to satisfy the restriction of the spatial relation.

In addition, the object data generating unit 1332 compares the number of the objects that should exist in a certain hierarchy and the number of the objects that are present at the present point of time, in the connection relation of the target system, and when the former is larger, may generate the objects for a shortage, satisfying the restriction of the spatial relation.

In addition, the inter-object relation data recording unit 134 may record the inter-object relation data composed of the spatial relation and the connection relation and the object data related to it altogether in a common expression form.

Also, the inter-object relation data generating unit 140 may include an installation surface object to install the object in the objects generating the relation data. By the configuration, the inter-object relation data can be generated for the objects installed on the same installation surface.

The display control unit 137 may hierarchically display the inter-object relation data recorded in the relation data storage unit 114 in two kinds of the connection relation and the spatial relation. The inter-object relation data recording unit 134 may put a flag to the object selected by the user, in the inter-object relation data stored in the relation data storage unit 114. By such a configuration, the display control unit 137 can turn the object selected in one relation display to the state of being selected even in the other relation display by referring to the relation data storage unit 114. Also, even when different display means is newly added, the display control unit 137 can perform display in the state in which the object is selected in the different display means by referring to the relation data storage unit 114. Also, the display control unit 137 may carry out reduction display of the hierarchies other than a partial hierarchy where the selected object is positioned. Thus, the relation data can be more simply displayed.

The inter-object relation data may have attribute information related to display control, based on a positional concept on the hierarchies in the target system. By such a configuration, display and non-display can be switched on the basis of the positional concept on the hierarchies.

The inter-object relation operation control unit 136 may add a pointer to the inter-object relation data recorded by the inter-object relation data recording unit 134 and the sum of the output power and the sum of the output power energy calculated by the electrical output calculating unit 135 to a log which manages a generating state of the inter-object relation data of the target system. By such a configuration, the inter-object relation operation control unit 136 can compare the plurality of system specifications held in the log, search the system specification suited to an installation purpose, and select and display the inter-object relation data of the target system suited to the installation purpose. Also, by such a configuration, the inter-object relation operation control unit 136 can extract a partial hierarchy where the object not satisfying a requested specification is positioned, and extract the partial hierarchy to be deleted or to be changed to a different object satisfying the requested specification.

Also, the system including a plurality of devices may distribute processing of the information processor 1 of the present embodiment to the plurality of devices and carry out the processing.

Various kinds of the above-described processing related to the information processor 1 may be carried out by recording a program for executing the processing of the information processor 1 of the present embodiment in a computer-readable storage medium and making a computer system read and execute the program stored in the storage medium.

Also, the “computer system” here may be one including an OS and hardware such as peripherals. Also, it is assumed that the “computer system” includes a homepage provision environment (or display environment) when a WWW system is utilized. The “computer-readable storage medium” is a writable nonvolatile memory such as a flexible disk, a magneto-optical disk, a ROM or a flash memory, a portable medium such as a CD-ROM, and a storage device such as a hard disk built in the computer system.

Furthermore, the “computer-readable storage medium” includes one that holds a program for a fixed period of time like a volatile memory (for instance, a DRAM (Dynamic Random Access Memory)) inside the computer system to be a server or a client when the program is transmitted through a network such as the Internet or a communication channel such as a telephone line. Also, the program may be transmitted from the computer system wherein the program is stored in a storage device or the like to another computer system through a transmission medium, or by transmission waves in the transmission medium. Here, the “transmission medium” which transmits the program is a medium having a function of transmitting information like the network (communication network) such as the Internet and the communication channel (communication line) such as the telephone line. Also, the program may be the one for achieving some of the above-described function. Furthermore, it may be one capable of achieving the above-described function by being combined with the program already recorded in the computer system, so-called a differential file (differential program).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processor that designs an target system in which a plurality of components are spatially arranged, the components whose kinds are different for each layer are electrically connected hierarchically, and electrical output of each component is inputted to a component in a next higher layer from the component, the information processor comprising:
an electrical connection relation generating unit which generates an electrical connection relation of the plurality of components by adjusting the electrical connection relation of the components determined by the number of connections which each component can make with other components and a kind of the components of each hierarchy, based on the number of the components of a predetermined kind that can be arranged in a given space and an electrical permissible amount of the component in a top layer of the hierarchy; and
a spatial arrangement determining unit which determines spatial arrangement of the components of the predetermined kind, based on the electrical connection relation generated by the electrical connection relation generating unit and rules of the spatial arrangement of the components.

2. The information processor according to claim 1,
wherein
the electrical connection relation is a tree structure, and
the spatial arrangement determining unit determines the spatial arrangement of the components of the predetermined kind so that the components of the predetermined kind within the same partial tree are spatially close.

3. The information processor according to claim 2,
wherein
the spatial arrangement determining unit determines the spatial arrangement of the components of the predetermined kind so that the components of the predetermined kind within the same partial tree are arranged closely in one line.

4. The information processor according to claim 3,
wherein
the spatial arrangement determining unit determines the spatial arrangement of the components of the predetermined kind, so that the components of the predetermined kind within the same partial tree are arranged in a partial space, where the arrangement of the components of the predetermined kind is not determined yet in the given space, over a plurality of lines within the partial space when the components of the predetermined kind within the same partial tree cannot be arranged closely in one line.

5. The information processor according to claim 3,
wherein
the spatial arrangement determining unit determines the spatial arrangement of the components of the predetermined kind, so that the components of the predetermined kind within the same partial tree are arranged in a partial space, where the arrangement of the components of the predetermined kind is not determined yet in the given space, over a plurality of areas that are spatially separated within the same line within the partial space when the components of the predetermined kind within the same partial tree cannot be arranged closely in one line.

6. The information processor according to claim 2,
wherein
the components of the predetermined kind are strings for which a plurality of solar cell panels are electrically connected, and
the spatial arrangement determining unit determines the spatial arrangement of the strings so that the strings within the same partial tree are spatially close.

7. The information processor according to claim 1,
wherein
the component in the top layer is a power conditioner.

8. The information processor according to claim 1,
wherein
the electrical connection relation generating unit comprises:
a number-of-components acquiring unit which acquires the number of the components of the predetermined kind that can be arranged in the given space based on information related to a range of the given space and information related to conditions of the arrangement of the components;
a connection relation generating unit which generates the electrical connection relation of the components, based on the number of connections which each component can make with other components and a kind of the components of each hierarchy;
an electrical output calculating unit which calculates a sum of the electrical output of the components of the predetermined kind, based on the electrical output of each of the components of the predetermined kind the number of which is at least a part of the number among the number of the components of the predetermined kind acquired by the number-of-components acquisition unit; and
a connection relation adjusting unit which compares the sum of the electrical output calculated by the electrical output calculating unit with the electrical permissible amount of the components in the top layer, and adjusting the number of the components in the electrical connection relation based on the comparison result.

9. The information processor according to claim 8, further comprising an input unit which receives a selection of the component to be a design object from a user, wherein
the electrical output calculating unit calculates the sum of the electrical output of the components of the predetermined kind, based on the electrical output of each component of the predetermined kind specified by the selection received by the input unit.

10. The information processor according to claim 8, further comprising
a relation restriction managing unit which determines the number of hierarchies of the electrical connection relation based on the electrical permissible amount of the predetermined component and acquires the kind of the components of each hierarchy based on the determined number of hierarchies,
wherein
the connection relation generating unit generates the electrical connection relation by the kind of the components of each hierarchy that is acquired by the relation restriction managing unit.

11. The information processing according to claim 8,
wherein
the components include strings to which solar cell panels are electrically connected, and
conditions of the arrangement of the components are an installation angle of the string to a ground surface, a size of an array loaded with at least one string, and a horizontal separation distance between the plurality of arrays.

12. The information processor according to claim 1, further comprising
an inter-object relation data generating unit which, after the spatial arrangement determining unit determines the spatial arrangement, generates connection relation data indicating the electrical connection relation between objects corresponding to the components based on the electrical connection relation generated by the electrical connection relation generating unit, and generates spatial relation data indicating a spatial position relation between the objects based on the spatial arrangement determined by the spatial arrangement determining unit.

13. The information processor according to claim 12, further comprising
an inter-object relation data recording unit which records the connection relation data and the spatial relation data.

14. The information processor according to claim 12, further comprising
a display control unit which makes a display device display at least one of the connection relation data and the spatial relation data.

15. An information processing method of designing an target system in which a plurality of components are spatially arranged, the components whose kinds are different for each layer are electrically connected hierarchically, and electrical output of each component is inputted to a component in a next higher layer from the component, the information processing method comprising:
a procedure of generating an electrical connection relation of the plurality of components by adjusting the electrical connection relation of the components determined by the number of connections which each component can make with other components and a kind of the components of each hierarchy, based on the number of the components of a predetermined kind that can be arranged in a given space and an electrical permissible amount of the component in a top layer of the hierarchy, by an electrical connection relation generating unit; and
a procedure of determining spatial arrangement of the components of the predetermined kind, based on the electrical connection relation generated by the electrical connection relation generating unit and rules of the spatial arrangement of the components, by a spatial arrangement determining unit.

16. A computer-readable storage medium storing a program that causes an information processor which designs an target system in which a plurality of components are spatially arranged, the components whose kinds are different for each layer are electrically connected hierarchically, and electrical output of each component is inputted to a component in a next higher layer from the component, to execute
electrical connection relation generation of generating an electrical connection relation of the plurality of components by adjusting the electrical connection relation of the components determined by the number of connections which each component can make with other components and a kind of the components of each hierarchy, based on the number of the components of a predetermined kind that can be arranged in a given space and an electrical permissible amount of the component in the top layer of the hierarchy, and
spatial arrangement determination of determining spatial arrangement of the components of the predetermined kind, based on the electrical connection relation generated by the electrical connection relation generation and rules of the spatial arrangement of the components.
